(19) United States
(12) Patent Application Publication
(10) Pub. No.: US 2006/0103143 A1
(43) Pub. Date: May 18, 2006

(54) Motor vehicle lock

(76) Inventors: Jean-Marc Belmond, St. Jean Le Blanc (FR); Philippe Ottolini, La Voivre (FR); Jean-Pierre Noel, Raon L'Etape (FR)

Correspondence Address: CARLSON, GASKEY & OLDS, P.C., 400 WEST MAPLE ROAD, SUITE 350, BIRMINGHAM, MI, 48009, US

(21) Appl. No.: 11/272,458

(22) Filed: Nov. 12, 2005

(30) Foreign Application Priority Data
Nov. 12, 2004 (FR) 04 12 025

(51) Int. Cl. E05C 3/06

(52) U.S. Cl. 292/201

(57) ABSTRACT

A lock has a locking state and/or an unlocking state. The lock includes a locking arm movable between a number of positions corresponding to the states of the lock and a motor with a drive shaft for driving the locking arm. The drive shaft defines a trajectory with respect to the locking arm. The lock also includes a locking rod articulated to the locking arm over the trajectory of the drive shaft with respect to the locking arm. The lock makes it possible to obtain a less bulky lock.

### REFERENCE TO RELATED APPLICATION

This application claims priority to French Patent Application FR 04 12 025 filed on Nov. 12, 2004.

### BACKGROUND OF THE INVENTION

The present invention relates generally to motor vehicle locks.

Locks make it possible to maintain a motor vehicle opening leaf in a closed position. They also make it possible to disengage the opening leaf by acting on an internal or external opening control which is connected to the lock that can be actuated by a user. Such a lock is typically mounted on the opening leaf of the vehicle. The lock includes a claw that functions to fix, with respect to the lock, a striker mounted on the vehicle or, on the contrary, to release the striker. Opening of the lock refers to the action of releasing the striker, thereby allowing the disengagement of the opening leaf. Conversely, closing the lock refers to the act of keeping the striker in the lock, thereby prohibiting the disengagement of the opening leaf. The claw is urged towards a closing position using the striker during the closure of the opening leaf. A pawl prohibits the claw from returning towards an opening position and maintains the lock in a closed position in the absence of an external action on the lock.

In this context, an external opening lever and an internal opening lever refer to the part of the lock connected to the external opening control and to the internal opening control, respectively. The lock is able to occupy a locking state or an unlocking state for the levers. In the locking state, the levers are locked, i.e., they do not allow opening actuation. In the unlocking state, the levers are unlocked, i.e., they allow opening actuation.

Document FR-A-2 835 867 describes a change of state of the lock produced by a device with a locking arm and a locking rod articulated to the locking arm. A motor permits actuation of the locking arm and the locking rod. In this document, the transmission of the movement from the motor to the locking arm is produced by a pinion of the motor, which causes a toothed ring to rotate. The ring is in one piece with the locking arm. The disadvantage with this device is that it makes the lock bulky.

There is therefore a need for a lock which is able to change a state and which is less bulky.

### SUMMARY OF THE INVENTION

The present invention provides a lock designed to occupy a locking state and/or an unlocking state. The lock includes a locking arm movable between a number of positions corresponding to the states of the lock and a motor with a drive shaft for driving the locking arm. The drive shaft describes a trajectory with respect to the locking arm. The lock also includes a locking rod articulated to the locking arm over the trajectory of the drive shaft with respect to the locking arm.

According to a variant, the locking arm includes an aperture defining the trajectory of the drive shaft with respect to the locking arm. According to a variant, the locking rod is articulated to a periphery of the aperture. According to a variant, the locking rod includes a slot, and the drive shaft engages the slot along the trajectory of the drive shaft with respect to the locking arm. According to a variant, the slot is open-ended, and the locking rod includes branches separated by the slot. The branches act on the periphery of the aperture. According to a variant, the aperture includes a portion with a circular periphery, and the locking rod is articulated to the circular periphery. According to a variant, the branches each include a stud cooperating with the portion with a circular periphery. According to a variant, the studs include a first surface cooperating with the portion having a circular periphery and a second surface delimiting a passage for the drive shaft in its trajectory with respect to the locking arm.

According to a variant, the lock additionally includes a toothed wheel driven by the motor. The wheel includes a cam driving the locking arm via a cam follower, and the cam follower is fixed to the locking arm. According to a variant, the trajectory of the drive shaft with respect to the locking arm passes through the articulation of the locking rod to the locking arm. According to a variant, the locking rod and the locking arm are articulated in a plane. The drive shaft extends through the locking rod and the locking arm in a direction transverse to the plane. According to a variant, the lock includes a case with a bearing for guiding the free end of the motor shaft.

### BRIEF DESCRIPTION OF THE DRAWINGS

Other features and advantages of the invention will become apparent on reading the detailed description below of embodiments of the invention which are given purely by way of example and with reference to the drawings, in which:

FIG. 1 shows a view of the lock according to an example of the invention in an unlocking state;

FIG. 2 shows a view of the lock according to an example of the invention in a locking state;

FIG. 3 shows a three-dimensional view of the lock according to FIGS. 1 and 2;

FIG. 4 shows a plan view of a locking arm of FIGS. 1 and 2;

FIG. 5 shows a plan view of a locking rod of FIGS. 1 and 2; and

FIG. 6 shows a view in section taken along line A-A of FIG. 2.

### DETAILED DESCRIPTION OF THE PREFERRED EMBODIMENTS

The invention relates to a lock which is able to change states and which includes a locking arm driven by a motor and its drive shaft. The locking arm is movable between a number of positions corresponding to the states of the lock. The drive shaft describes a trajectory with respect to the moving locking arm. The lock also includes a locking rod being articulated to the locking arm over the trajectory of the drive shaft with respect to the locking arm, thereby making the lock less bulky. Specifically, this makes it possible to superpose the motor on the locking rod and the locking arm and therefore to group together the components of the lock.

In the description which follows, the words vertical, horizontal, left, right, top and bottom will be used to refer to the position of the lock represented in the Figures. This position is illustrative and should not be understood as limiting the position of the lock during operation.

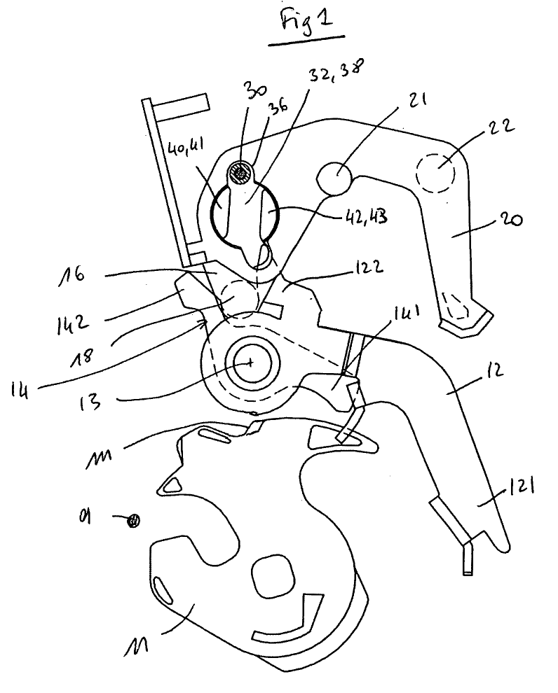

FIG. 1 shows a lock 10 in a state referred to as an unlocking state. In this state, the lock 10 is opened when acting on the internal or external opening controls. FIG. 1 shows only an external opening lever 12 which is mounted to rotate about an axis 13. The external opening lever 12 includes an end 121 to which there is connected a cable (not shown) for activating the external opening lever 12 via an external opening control (not shown either). FIG. 1 also shows a pawl 14 mounted to rotate about the axis 13. At an end 141, the pawl 14 is able to come into contact with a shoulder 111 of a claw 11 to block the claw 11 against rotation. In FIG. 1, the pawl 14 has been made to rotate counter-clockwise about the axis 13, which releases the claw 11. The claw 11 has in turn released a striker 9 of the vehicle. The release of the striker 9 results in the opening of the lock 10. The rotation of the pawl 14 to release the striker 9 is achieved by virtue of the rotation of the external opening lever 12.

It is possible for the pawl 14 to be driven by the external opening lever 12 by virtue of the presence of a locking rod 16 interposed between the external opening lever 12 and the pawl 14. More specifically, the external opening lever 12 includes a bearing surface 122 which butts against a pin 18 of the locking rod 16 during the rotation of the external opening lever 12 in the counter-clockwise direction. The pin 18 itself butts against an end 142 of the pawl 14, which allows the pawl 14 to rotate in the counter-clockwise direction. The rotation of the pawl 14 has withdrawn the end 141 from the shoulder 111 of the claw 11.

FIG. 1 also shows a locking arm 20. The locking arm 20 can move rotationally in the lock 10 about an axis of rotation 22. The locking arm 20 enables the locking rod 16 to be driven. The locking rod 16 is articulated to the locking arm 20, as will be described in more detail below. The locking rod 16 is articulated to the locking arm 20 in such a way as to be able to move independently of the locking arm 20. In particular, in FIG. 1, the locking rod 16 may be caused to rotate between the pawl 14 and the external opening lever 12 without a change in the position of the locking arm 20.

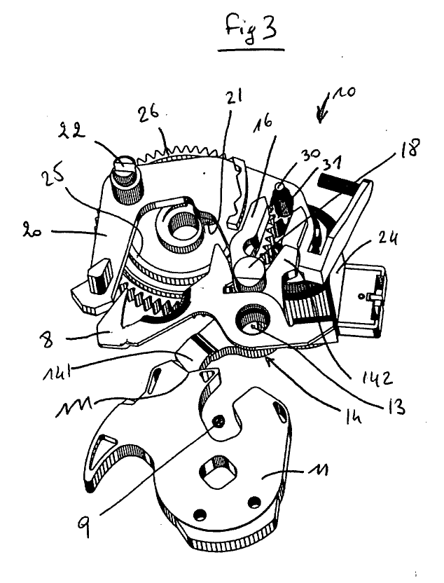

The lock 10 also includes a motor 24 for actuating the locking arm 20, which can be seen in FIG. 3. The motor 24 includes a drive shaft 30 for driving the locking arm 20, and the drive shaft 30 is visible in FIG. 1. The driving of the locking arm 20 by the motor 24 is described in more detail in connection with FIG. 3.

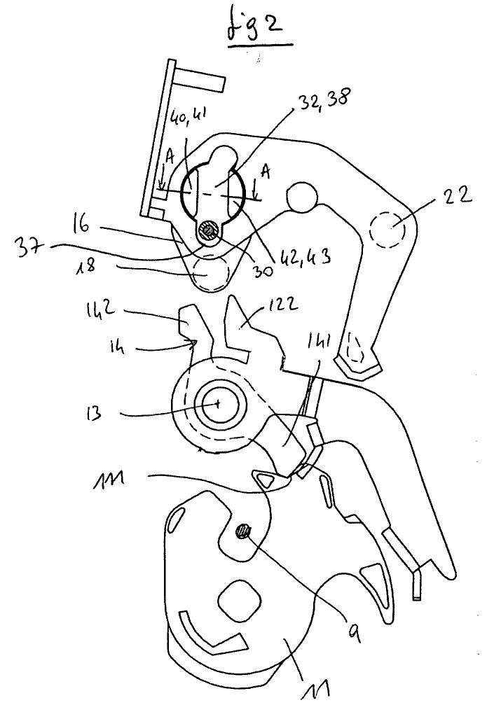

In the unlocking state shown in FIG. 1, the motor 24 has moved the locking arm 20 to insert the locking rod 16 between the external opening lever 12 and the pawl 14. In FIG. 2, the motor 24 causes the locking arm 20 to rotate in the clockwise direction about the axis 22. FIG. 2 shows that the locking rod 16 is no longer between the external opening lever 12 and the pawl 14, and the lock 10 then is in a different state. The locking arm 20 is able to move between a number of positions, including those of FIGS. 1 and 2, corresponding to various states of the lock 10, including those of FIGS. 1 and 2.

FIG. 2 shows the lock 10 in a state referred to as the locking state. FIG. 2 shows the same lock elements as FIG. 1. In the state shown in FIG. 2, the lock 10 is closed, and the striker 9 is confined within the claw 11. The lock 10 is in the locked state since opening of the lock 10 can no longer be obtained when acting on the internal or external opening controls. Specifically, the action on an external opening control acts on the external opening lever 12, which turns in the counter-clockwise direction about the axis 13 as in FIG. 1. However, and unlike FIG. 1, the external opening lever 12 (which has a limited angular displacement) is no longer able to drive the pawl 14 since the locking rod 16 can no longer transmit the movement of the external opening lever 12 to the pawl 14. The external opening lever 12 is actuated in a void, and the pawl 14 remains immobile. The claw 11 is thus unable to release the striker 9 to open the lock 10.

FIGS. 1 and 2 show only a single lever, namely the external opening lever 12. However, the lock 10 may contain another lever, namely an internal opening lever. The description which has been given with respect to the locking or the unlocking of the external opening lever 12 may be similarly applied to the internal opening lever. In particular, when the lock 10 is in the unlocked state, the internal opening lever can drive the pawl 14 and the claw 11 by way of the locking rod 16. When the lock 10 is in the locked state, the internal opening lever can no longer drive the pawl 14 and the claw 11 since the locking rod 16 is displaced. A number of locking and unlocking combinations for the levers enable the lock 10 to occupy various operating states.

FIG. 3 shows a three-dimensional rear view of the lock 10 shown in FIG. 1. The claw 11 retaining the striker 9 and the pawl 14 movable about the axis 13 and having the end 141 blocking the claw 11 in contact with the shoulder 111 are represented. It is also possible to see the locking arm 20 driving the locking rod 16. The locking rod 16 bears the pin 18 by means of which the external opening lever 12 (not shown) drives the pawl 14. FIG. 3 also represents a counter-pawl 8, allowing opening of the lock 10 by the above-stated internal opening lever. The operation of the counter-pawl 8 is not described further.

The locking arm 20 is able to move about the axis 22 by virtue of the motor 24 represented “under” the lock 10. The motor 24 drives, via a pinion 31 mounted on the drive shaft 30, a toothed wheel 26 represented “under” the lock 10. The locking arm 20 can be driven by the toothed wheel 26 by way of a cam 25 (fixed to the toothed wheel 26) and of a cam follower 21 (fixed to the locking arm 20). The cam/cam follower device does not form the subject of the invention. Such a device is described in a patent application filed on the same date as the present application and by the same applicant. The device makes it possible to replace the use of a toothed ring in one piece with the locking arm 20. The advantage of the toothed wheel/pinion device for driving the locking arm 20 is the ability to modify the ratio between the teeth of the pinion and of the toothed wheel 26 and thus more easily adjust the rotational torque of the locking arm 20. The toothed wheel 26 and the motor 24 have not been represented in FIGS. 1 and 2 to improve the clarity of the figures.

Returning to FIGS. 1 and 2, the drive shaft 30 describes a trajectory with respect to the locking arm 20. Moreover, the locking rod 16 is articulated to the locking arm 20 over the trajectory of the drive shaft 30 with respect to the locking arm 20. This makes it possible to superpose the drive motor 24 on the locking rod 16 and the locking arm 20 instead of offsetting the motor 24 to a region of the lock 10 where the lock mechanism does not interfere with the motor 24. Thus, in projection in a plane defined by the locking arm 20, the motor 24 does not occupy any additional space, and the lock 10 obtained is less bulky. The drive for the locking rod 16 is also less bulky, allowing the set-up in which the toothed wheel 26 is employed to drive the locking arm 20. Varying the reduction ratio between the pinion 31 and the toothed wheel 26 results in a wider range of a reduction ratio for the locking arm 20.

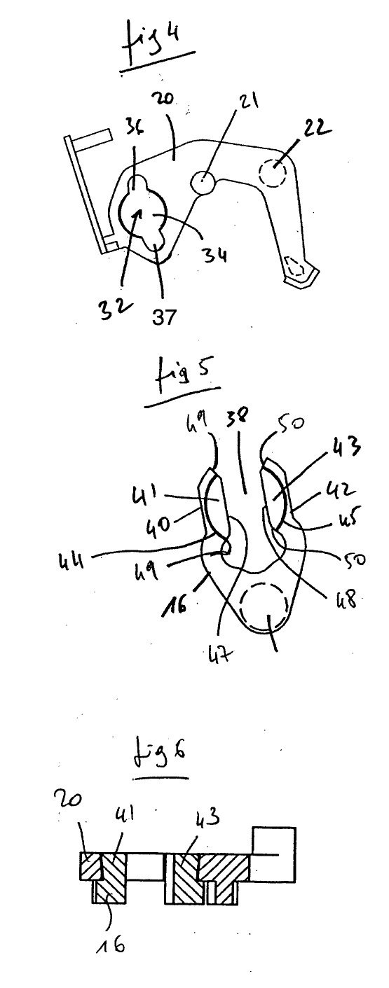

FIGS. 4 and 5 show more precisely the articulation of the locking rod 16 to the locking arm 20, and the trajectory of the drive shaft 30 of the motor 24 with respect to the locking arm 20.

FIG. 4 shows a plan view of the locking arm 20. The locking arm 20 includes an aperture 32. As can be seen in FIGS. 1 and 2, the aperture 32 defines a trajectory of the drive shaft 30 with respect to the motor 24. The aperture 32 has a circular-arc or bean shape with an upper end 36 and a lower end 37. The bean shape makes a circular-arc displacement or trajectory possible for the drive shaft 30 in the aperture 32, while the locking arm 20 has a rotational movement about the axis 22. The aperture 32 may also include a portion 34 which is widened with respect to the ends 36 and 37. The portion 34 has a circular shape and the periphery of the portion 34 cooperates with the locking rod 16 in an articulated connection. The portion 34 may be central with respect to the aperture 32, and the ends 36 and 37 are on either side of the portion 34. As can be seen in FIG. 3, the drive shaft 30 passes through the locking arm 20 via the aperture 32.

FIG. 5 shows a plan view of the locking rod 16. The locking rod 16 includes a slot 38. As can be seen in FIGS. 1 and 2, the drive shaft 30 engages in the slot 38 along the trajectory of the drive shaft 30 with respect to the locking arm 20. Thus, the locking rod 16 articulated to the locking arm 20 does not impede the movement of the locking arm 20 with respect to the drive shaft 30.

Advantageously, the slot 38 is open-ended and the locking rod 16 includes branches 40 and 42. The branches 40 and 42 act on the periphery of the aperture 32. The slot 38 is open-ended in the sense that the slot 38 is open at one end of the locking rod 16. The slot 38 thus defines a fork with the two branches 40 and 42. The open-ended slot 38 makes it possible for the free ends of the branches 40 and 42 to be urged elastically towards one another to cause the locking rod 16 to enter the aperture 32 in the locking arm 20. Once in place, the branches 40 and 42 tend to move apart, acting on the periphery of the aperture 32. This allows the locking rod 16 to be held in place with respect to the locking arm 20.

The locking rod 16 is, for example, articulated to the portion 34 having a circular periphery. This allows the locking rod 16 to move rotationally with respect to the locking arm 20.

The branches 40 and 42 may each have studs 41 and 43 cooperating with the periphery of the aperture 32, in particular with the portion 34. In projection in the plane of the locking rod 16, the studs 41 and 43 may have a first circular-arc-shaped surface 44 and 45. The surfaces 44 and 45 are able to cooperate with the substantially circular central portion 34 of the aperture 32. The studs 41 and 43 may also each have a second surface 47 and 48 delimiting a region in which the drive shaft 30 is free to pass in its trajectory with respect to the locking arm 20. The cooperation of the studs 41 and 43 with the portion 34 of the aperture 32 is one way of articulating the locking rod 16 to the locking arm 20. It is also possible that the studs 41 and 43 are fixed to the locking arm 20. The branches 40 and 42 then act on the studs 41 and 43 to obtain the articulated connection between the locking arm 20 and the locking rod 16.

The trajectory of the drive shaft 30 with respect to the locking arm 20 passes through the articulation of the locking rod 16 to the locking arm 20. This allows the locking rod 16 to be articulated to the locking arm 20 without impeding the movement of the drive shaft 30 with respect to the locking arm 20.

FIG. 5 also shows chamfers 49 and 50 both upstream and downstream of the studs 41 and 43 along the slot 38. This allows better engagement of the drive shaft 30 in the slot 38 in one direction of the trajectory.

Moreover, the locking rod 16 is symmetrical so that it can be mounted equally on the lock 10 of a right or left opening leaf of a vehicle. This avoids the construction of a locking rod 16 for each side of the vehicle.

FIGS. 1 and 2 show plan views of the assembled locking rod 16 and the locking arm 20. These figures show not only the articulation movement between the locking rod 16 and the locking arm 20, but also the trajectory of the drive shaft 30 with respect to the locking arm 20.

FIG. 1 shows the lock 10 in the unlocked state. The branches 40 and 42 urge the studs against the periphery of the circular portion of the aperture 32, allowing the locking rod 16 to be held in place with respect to the locking arm 20. The branches 40 and 42 act on the periphery of the aperture 32 in opposite directions, and the passage for the drive shaft 30 between the branches 40 and 42 are left free. The surface 44 and 45 of the studs 41 and 42 cooperates with the periphery of the portion 34 of the aperture 32 to bring about an articulation (rotational) movement between the locking rod 16 and the locking arm 20. Specifically, with respect to FIG. 2, the locking rod 16 does not have the same angular position with respect to the locking arm 20. The locking rod 16 has been caused by the external opening lever 12 to perform a rotational movement in the clockwise direction. The locking rod 16 is articulated to the locking arm 20 in an articulation plane, which is the plane of the FIG. 1. Furthermore, the drive shaft 30 is represented by a circle in cross section. The drive shaft 30 is at the upper end 36 of the aperture 32. In the position shown in FIG. 1, the drive shaft 30 is disengaged from the slot 38 in the locking rod 16, which allows the locking rod 16 also to perform the rotational movement with respect to the locking arm 20.

FIG. 1 shows the trajectory which can be followed by the drive shaft 30 with respect to the locking arm 20 within the aperture 32. This trajectory is towards the lower end 37 of the aperture 32 when the locking arm 20 performs a rotational movement about the axis 22 in the clockwise direction. This is shown in FIG. 2.

FIG. 2 shows the lock 10 in the locked state. The locking arm 20 has performed a rotational movement in the clockwise direction. The drive shaft 30 has left the end 36 of the aperture 32 and then engaged in the slot 38 in the locking rod 16, the engagement being facilitated by the presence of the chamfers 49 and 50. The drive shaft 30 has subsequently traveled as far as the end 37 of the aperture 32. The movement of the drive shaft 30 along the length of the slot 38 is facilitated by the surfaces 47 and 48 (FIG. 5) of the studs 41 and 43. In the course of the rotational movement of the locking arm 20 between the two FIGS. 1 and 2, the drive shaft 30 has passed through the articulation of the locking rod 16 to the locking arm 20 along the trajectory of the drive shaft 30.

Moreover, FIG. 3 shows that the drive shaft 30 is visible on the side of the lock 10 represented to the front in FIG. 1. This side corresponds to the rear of the lock 10 in FIGS. 1 and 2. The drive shaft 30 is rotationally driven on one side of the lock 10 by the motor 24 (at the bottom in FIG. 3) and is guided in its rotation by a bearing (not shown) on the other side of the lock 10. The bearing is on the lock case (not shown). The bearing prevents the drive shaft 30 from projecting from the motor 24 in a overhang position. From the motor 24 to the bearing, the drive shaft 30 extends on either side of the locking arm 20 through the aperture 32. Furthermore, when the locking arm 20 is moved rotationally driving the locking rod 16, the drive shaft 30 is also able to extend on either side of the locking rod 16. The drive shaft 30 extends through the locking rod 16 and the locking arm 20 along the trajectory of the drive shaft 30 with respect to the locking arm 20 in a direction transverse to the plane in which the locking rod 16 is articulated to the locking arm 20. This enables the free end of the drive shaft 30 to be guided rotationally without impeding the movement of the locking arm 20 and of the locking rod 16.

FIG. 6 is a view in section along line A-A of FIG. 2. In FIG. 6, the studs 41 and 43 have a reverse taper, and the locking arm 20 has a taper. The cooperation between the taper and the reverse taper enables the locking rod 16 to be better held by the locking arm 20.

Of course, the present invention is not limited to the embodiments described by way of example. Thus, the invention may be applied to other states of the lock than those mentioned above. Equally, the shape of the aperture 32 is not limited to that described in relation to FIG. 3. In fact, the aperture 32 may be entirely circular, the rod then being made to match such a shape. However, the shape shown in FIG. 4 is a good compromise between the size of the locking arm 20 (in particular around the aperture) and the solidity of the locking arm 20 (in particular around the aperture).

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A lock having a locking state and an unlocking state, the lock comprising:
a locking arm movable between a plurality of positions corresponding to a state of the lock;
a motor including a drive shaft for driving the locking arm, wherein the drive shaft defines a trajectory with respect to the locking arm; and
a locking rod connected to the locking arm over the trajectory of the drive shaft.

2. The lock according to claim 1, wherein the locking arm includes an aperture that defines the trajectory of the drive shaft.

3. The lock according to claim 2, wherein the locking rod is connected to a periphery of the aperture of the locking arm.

4. The lock according to claim 3, wherein the locking rod includes a slot, and the drive shaft engages in the slot along the trajectory of the drive shaft.

5. The lock according to claim 4, wherein the slot is open-ended and the locking rod includes branches separated by the slot, and the branches act on the periphery of the aperture of the locking arm.

6. The lock according to claim 5, wherein the aperture of the locking arm includes a portion having a circular periphery, and the locking rod is connected to the circular periphery.

7. The lock according to claim 6, wherein the branches of the locking rod each include a stud that cooperates with the portion of the aperture of the locking arm.

8. The lock according to claim 7, wherein the studs each include a first surface that cooperates with the portion of the aperture of the locking arm and a second surface delimiting a passage for the drive shaft in the trajectory of the drive shaft.

9. The lock according to claim 1, further including a toothed wheel driven by the motor, wherein the toothed wheel includes a cam that drives the locking arm via a cam follower, and the cam follower is fixed to the locking arm.

10. The lock according to claim 1, wherein the trajectory of the drive shaft passes through a connection of the locking rod to the locking arm.

11. The lock according to claim 1, wherein the locking rod and the locking arm are connected in a plane, and the drive shaft extends through the locking rod and the locking arm in a direction transverse to the plane.

12. The lock according to claim 1, wherein the drive shaft includes a free end and the lock includes a case with a bearing for guiding the free end of the drive shaft.

13. A lock having a locking state and an unlocking state, the lock comprising:
a locking arm movable between a plurality of positions corresponding to a state of the lock;
a motor including a drive shaft for driving the locking arm, wherein the drive shaft defines a trajectory with respect to the locking arm; and
a locking rod connected to the locking arm over the trajectory of the drive shaft, wherein the trajectory passes through a connection of the locking rod to the locking arm.

14. The lock according to claim 13, wherein the locking arm includes an aperture that defines the trajectory of the drive shaft.

15. The lock according to claim 14, wherein the locking rod is connected to a periphery of the aperture of the locking arm.

16. The lock according to claim 15, wherein the locking rod includes a slot, and the drive shaft engages in the slot along the trajectory of the drive shaft.

17. The lock according to claim 16, wherein the slot is open-ended and the locking rod includes branches separated by the slot, and the branches act on the periphery of the aperture of the locking arm.

18. The lock according to claim 13, wherein the drive shaft includes a free end and the lock includes a case with a bearing for guiding the free end of the drive shaft.

19. A lock having a locking state and an unlocking state, the lock comprising:
a locking arm movable between a plurality of positions corresponding to a state of the lock;
a motor including a drive shaft for driving the locking arm, wherein the drive shaft defines a trajectory with respect to the locking arm;
a locking rod connected to the locking arm over the trajectory of the drive shaft, wherein the locking rod is connected to a periphery of an aperture in the locking arm over the trajectory of the drive shaft, and the trajectory of the drive shaft passes through a connection of the locking rod to the locking arm; and
a case with a bearing for guiding a free end of the drive shaft.

20. The lock according to claim 19, wherein the locking rod includes a slot, and the drive shaft engages in the slot along the trajectory of the drive shaft.
